(19) United States
(12) Patent Application Publication
(10) Pub. No.: US 2026/0028260 A1
(43) Pub. Date: Jan. 29, 2026

(54) MOBILE ULTRAPURE WATER SYSTEM

(71) Applicant: Evoqua Water Technologies LLC, Pittsburgh, PA (US)

(72) Inventor: Alex J. Hunter, New Brighton, PA (US)

(21) Appl. No.: 18/997,122

(22) PCT Filed: Jul. 20, 2023
(86) PCT No.: PCT/US2023/028214

§ 371 Date: Jan. 20, 2025

Related U.S. Application Data
(60) Provisional application No. 63/390,685, filed on Jul. 20, 2022.
(60) Provisional application No. 63/422,024, filed on Nov. 3, 2022.

(51) Int. Cl. C02F 9/00; C02F 1/00; C02F 1/30; C02F 1/42; C02F 1/44; C02F 1/469

(52) U.S. Cl. CPC C02F 9/00; C02F 1/001; C02F 1/30; C02F 1/42; C02F 2001/427; C02F 1/444; C02F 1/4695; C02F 2201/006; C02F 2201/007; C02F 2201/008; C02F 2201/322; C02F 2209/03; C02F 2209/40

(57) ABSTRACT

A mobile, modular water treatment system for the production of ultrapure water includes a storage tank, an actinic radiation treatment apparatus disposed on a mobile platform, an electrically driven water treatment apparatus disposed on the mobile platform, downstream of the actinic radiation treatment apparatus, an ion exchange media apparatus disposed on the mobile platform downstream of the electrically driven water treatment apparatus, and a pressure driven filtration sub-system disposed on the mobile platform downstream of the ion exchange media apparatus. The pressure driven filtration sub-system outputs the ultrapure water and is connectable to a water distribution system for a point of use and for recirculation of a portion of the ultrapure water to the storage tank.

### FIELD OF TECHNOLOGY

Aspects and embodiments disclosed herein relate to a mobile and/or temporary ultrapure water system for use in, e.g., the construction of microelectronics facilities.

### SUMMARY

In accordance with an aspect, there is provided a mobile, modular water treatment system for the production of ultrapure water for use as primary level water for rinse or makeup water in a semiconductor fabrication facility. The system comprises a storage tank having an inlet configured to receive pretreated water from an upstream water pretreatment system, and an outlet, a mobile platform, an actinic radiation treatment apparatus disposed on the mobile platform, the actinic radiation treatment apparatus having an inlet configured to receive the pretreated water from the outlet of the storage tank, and a source of actinic radiation configured to irradiate the pretreated water and destroy organic contaminants in the pretreated water to form a first partially treated water, an electrically driven water treatment apparatus disposed on the mobile platform, the electrically driven water treatment apparatus having an inlet configured to receive the first partially treated water from the actinic radiation treatment apparatus and configured to remove ionic contaminants from the first partially treated water to form a second partially treated water, an ion exchange media apparatus disposed on the mobile platform and including ion exchange media, the ion exchange media apparatus configured to receive the second partially treated water from the electrically driven water treatment apparatus and remove one or more ionic species from the second partially treated water to form a third partially treated water, and a pressure driven filtration sub-system disposed on the mobile platform and configured to filter particulate matter from the third partially treated water to form the ultrapure water, the pressure driven filtration sub-system being connectable to a water distribution system for the semiconductor fabrication facility and for recirculation of a portion of the ultrapure water to the storage tank.

In some embodiments, the storage tank is insulated and includes a nitrogen blanket system configured to cover the pretreated water in the storage tank with nitrogen gas.

In some embodiments, the actinic radiation treatment apparatus is configured to perform an advanced oxidation process on the pretreated water.

In some embodiments, the electrically driven water treatment apparatus includes a continuous electrodeionization apparatus.

In some embodiments, the ion exchange media apparatus includes a mixed bed of ion exchange media.

In some embodiments, the pressure driven filtration sub-system includes a first particle filter having a particle retention size of about 0.1 μm or greater.

In some embodiments, the pressure driven filtration sub-system further includes a membrane filtration apparatus.

In some embodiments, the membrane filtration apparatus includes an ultrafilter.

In some embodiments, the system is configured produce the ultrapure water with an electrical resistivity of greater than or equal to 18 MΩ, a total organic contaminant level of less than 10 ppb, and 1000 particles per liter or fewer having a size of from 0.1-0.2 microns from the pretreated water having an electrical resistivity of 0.1 MΩ or less, and a total organic contaminant level of 50 ppb or less.

In some embodiments, the mobile platform includes at least two mobile containers.

In some embodiments, the storage tank includes a second inlet configured to receive ultrapure water.

In some embodiments, the system further comprises water quality and flow sensors disposed downstream of the pressure driven filtration sub-system, and a controller configured to control output of the ultrapure water to the semiconductor fabrication facility based on measurements from the water quality and flow sensors.

In some embodiments, the system further comprises a second mobile platform configured to produce the pretreated water from city water and deliver the pretreated water to the storage tank.

In accordance with another aspect, there is provided a method of facilitating temporary production of ultrapure water for use in a pre-commissioned semiconductor fabrication facility as primary level water for rinse or makeup water. The method comprises providing a storage tank configured to connect to and receive pretreated water from an upstream water pretreatment system, delivering a mobile platform to the pre-commissioned semiconductor fabrication facility. The mobile platform includes an actinic radiation treatment apparatus having an inlet configured to connect to and receive the pretreated water from the storage tank, and a source of actinic radiation configured to irradiate the pretreated water to destroy organic contaminants in the pretreated water and form a first partially treated water, an electrically driven water treatment apparatus having an inlet configured to connect to and receive the first partially treated water from the actinic radiation treatment apparatus and to remove ionic contaminants from the first partially treated water and form a second partially treated water, an ion exchange media apparatus including ion exchange media, the ion exchange media apparatus configured to connect to and receive the second partially treated water from the electrically driven water treatment apparatus and remove one or more ionic species from the second partially treated water and form a third partially treated wastewater, and a pressure driven filtration sub-system configured to connect to and receive the third partially treated water from the ion exchange media apparatus and remove particulate matter from the third partially treated water to form the ultrapure water, the pressure driven filtration sub-system including an outlet connectable to a water distribution system for the pre-commissioned semiconductor fabrication facility and for recirculation of a portion of the ultrapure water to the storage tank.

In some embodiments, providing the storage tank includes providing a nitrogen blanket production sub-system configured to maintain a blanket of nitrogen gas over the pretreated water in the storage tank.

In some embodiments, the method further comprises configuring the actinic radiation treatment apparatus to perform an advanced oxidation process on the pretreated water.

In some embodiments, the method further comprises configuring the electrically driven water treatment apparatus to subject the first partially treated water to a continuous electrodeionization process.

In some embodiments, the method further comprises configuring the ion exchange media apparatus to pass the second partially treated water through a mixed bed of ion exchange media.

In some embodiments, the method further comprises configuring the pressure driven filtration sub-system to include an upstream particle filter configured to remove particulate matter with a size of about 0.1 μm or greater from the third partially treated water, and an ultrafiltration apparatus downstream of the upstream particle filter.

In some embodiments, the method further comprises providing water quality and flow sensors to be disposed downstream of the pressure driven filtration sub-system and a controller configured to control output of the ultrapure water to the semiconductor fabrication facility based on measurements from the water quality and flow sensors.

In some embodiments, the method further comprises providing instructions to mix recirculated ultrapure water from the pressure driven filtration sub-system with the pretreated water in the storage tank.

In some embodiments, the method further comprises providing a second mobile platform including the upstream water pretreatment system.

### BRIEF DESCRIPTION OF THE DRAWINGS

The accompanying drawings are not drawn to scale. In the drawings, each identical or nearly identical component that is illustrated in the various figures is represented by a like numeral. For purposes of clarity, not every component may be labeled in every drawing. In the drawings:

FIG. 1A illustrates one example of a sub-system of a mobile ultrapure water production system configured to produce water having first quality parameters from feed water;

FIG. 1B illustrates one example of a sub-system of a mobile ultrapure water production system configured to produce water having quality parameters superior to the first quality parameters from water output from a sub-system such as illustrated in FIG. 1A or FIG. 2A;

FIG. 2A illustrates another example of a sub-system of a mobile ultrapure water production system configured to produce water having first quality parameters from feed water; and

FIG. 2B illustrates another example of a sub-system of a mobile ultrapure water production system configured to produce water having quality parameters superior to the first quality parameters from water output from a sub-system such as illustrated in FIG. 1A or FIG. 2A.

### DETAILED DESCRIPTION

During the semiconductor manufacturing process, large volumes of ultrapure water (UPW) are used in many steps of the process to rinse various chemicals and particulate materials from the devices. This ultrapure water should meet stringent quality requirements to be used, as contaminants present in the ultrapure water can have negative effect on the yield of the semiconductor devices. These contaminants can comprise organic and inorganic compounds, along with particulate matter. As semiconductor devices continue to improve and become smaller, the quality of ultrapure water used during manufacturing should also improve.

Many different water purification processes are used to treat water to obtain ultrapure water. These processes often include (but are not limited to) pressure-driven membrane processes such as reverse osmosis (RO) and nanofiltration, deionization processes such as electrodeionization and regenerable ion exchange, and particulate removal processes such as ultrafiltration (UF) and sub-micron particle filters.

Due to the importance of ultrapure rinse water to the semiconductor manufacturing process, ultrapure water systems are typically permanently installed in microelectronics facilities. However, during initial construction of microelectronics facilities and prior to installation of these permanent ultrapure water systems, access to ultrapure water may still be desired for tasks such as, e.g., cleaning and/or hydraulically testing piping expansions, rinsing new equipment before installation, etc. As the permanent ultrapure water system may not be on-line during this initial construction phase, delays in the commissioning and start-up of new microelectronics facilities may occur due to the lack of access to ultrapure water.

Accordingly, there is a need for a temporary system capable of providing ultrapure quality water.

In accordance with an aspect of the present disclosure, an ultrapure water system is disclosed. More specifically, a temporary and/or mobile ultrapure water system capable of use in at least the initial construction of microelectronics facilities is disclosed.

Aspects and embodiments of a temporary and/or mobile ultrapure water system as disclosed herein may include two primary sub-systems—a makeup water sub-system to treat influent feed water, for example, potable city water to a first high level of purity by the use of various unit operations including a dual pass RO filtration unit operation, and a polishing sub-system to bring the water output from the makeup water sub-system to a second higher level of purity that is sufficient for use as ultrapure water for use in various operations associated with, for example, commissioning a semiconductor manufacturing system.

In some embodiments, the temporary ultrapure water system may include self-cleaning screen filtration (e.g., VAF™ screen filtration from Evoqua Water Technologies LLC, Pittsburgh, PA), chemical pretreatment (antiscalant and sodium bisulfite), and double pass reverse osmosis (RO) with interstage membrane degasification in the makeup water sub-system.

The polishing sub-system may include a nitrogen blanketed storage tank, total organic carbon (TOC) destruct UV, electrodeionization (e.g., IONPURE® VNX continuous electrodeionization (CEDI) module from Evoqua Water Technologies LLC, Pittsburgh, PA), high purity ion exchange filtration, and high purity cartridge filtration.

It is to be understood that more or fewer water filtration and/or purification devices or modules may be provided in accordance with the present disclosure.

In some embodiments, at least some of the various components of the temporary ultrapure water system may be housed in one or more mobile container(s) or trailer(s), also referred to herein as mobile platforms. For example, in some embodiments five (5) separate mobile containers (e.g., trailers) may be utilized, with the self-cleaning screen filtration and chemical pretreatment devices housed in a first container, a first RO device and interstage membrane degasification device housed in a second container, a second RO device housed in a third container, the TOC destruct and electrodeionization devices housed in a fourth container, and the ion exchange filtration and cartridge filtration devices housed in a fifth container. In some embodiments, the storage tank may be located external to any mobile container in the system. However, in other embodiments, the storage tank may be located in a mobile container, be it a dedicated mobile container or a mobile container including other components of the ultrapure water system. Additionally, in some embodiments, each mobile container may include a booster pump to move water through the system. Each mobile container may be fluidly coupled to another adjacent mobile container by way of appropriate piping. In this way, the ultrapure water system may be substantially modular and mobile, enabling the system to be easily deployed to, e.g., a microelectronics facility under construction so as to provide ultrapure rinse water prior to start-up of the facility. Once the facility is completed, the temporary ultrapure water system may be removed from the site, typically in favor of a permanent ultrapure water system associated with the production of semiconductors.

In some embodiments, the quality of water provided by the temporary ultrapure water system need not meet the same quality standards (e.g., ASTM E1.2) as would be provided by a permanent ultrapure water system used in, e.g., semiconductor manufacturing. For example, the quality of water provided by the temporary ultrapure water system could be of intermediate quality, below ASTM E1.2 grade but greater than that provided by, e.g., a reverse osmosis deionization system. In this way, the temporary ultrapure water system would be suitable to provide ultrapure rinse water during commissioning of a microelectronics facility but would not necessarily be suitable to provide ultrapure water needed for the production of microelectronics. However, in other embodiments, the temporary ultrapure water system could be configured to provide ultrapure water of a quality suitable for microelectronics manufacturing.

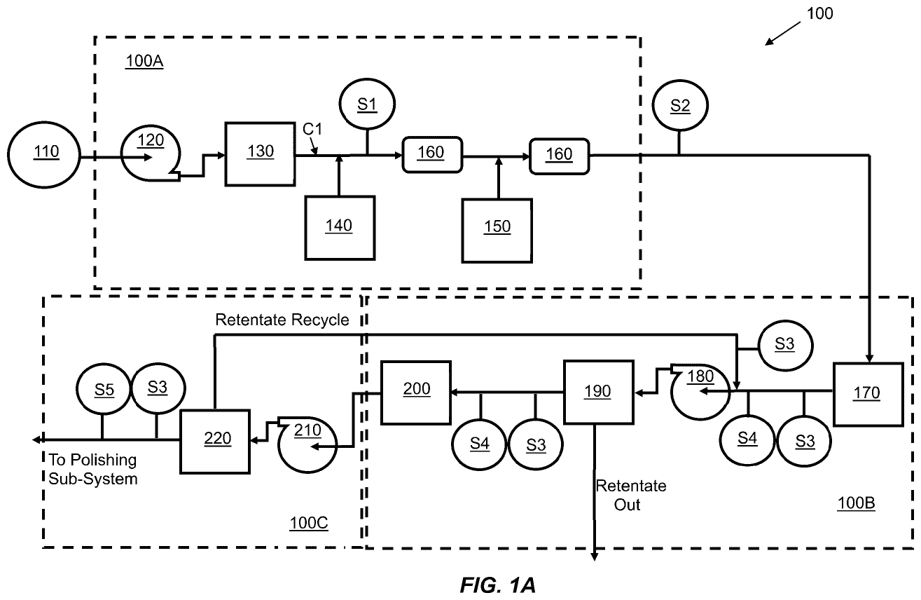

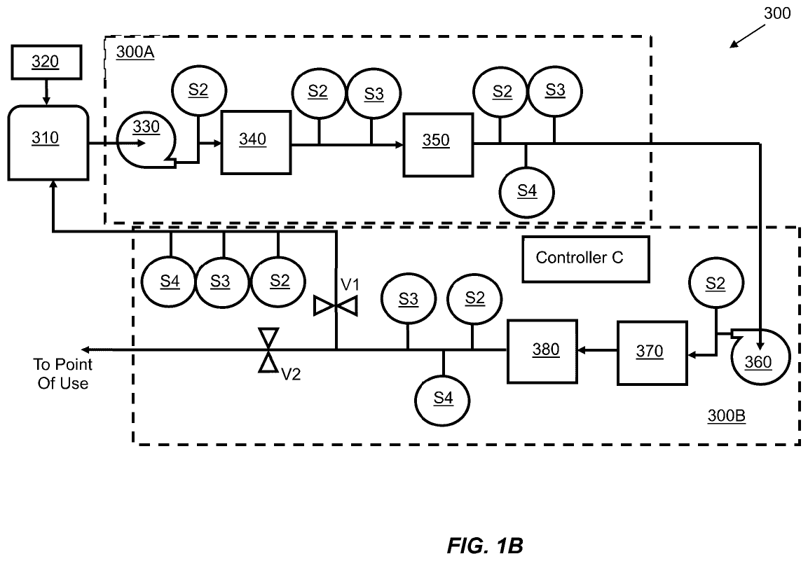

FIG. 1A illustrates a first embodiment of a makeup water sub-system 100 for a mobile/temporary ultrapure water system as disclosed herein.

The makeup water sub-system 100 receives feed water, which may meet standards for potable water from, for example, a municipal water source 110. The feed water is directed into a first mobile container 100A and pressurized by a first booster pump 120, for example, a variable frequency drive pump. The first booster pump 120 pumps the feed water through a filter 130, for example, a self-cleaning VAF™ screen filtration unit from Evoqua Water Technologies LLC, that may have a particle retention size of from about 10 μm to about 25 μm. The filtered feed water passes through a conduit Cl in which it is dosed with chemical pretreatment agents, for example, sodium bisulfate from a source of sodium bisulfate 140 and antiscalant (for example, one of the Vitec™ products available from Avista Membrane Solutions, such as Vitec™ 3000) from a source of antiscalant 150. The amount of sodium bisulfate dosed into the filtered feed water may be controlled based on oxygen-reduction potential (ORP) readings from an ORP sensor S1 disposed downstream of the injection point of the sodium bisulfate. Static mixers 160 may be disposed downstream of the injection points for each of the sodium bisulfate and antiscalant to help thoroughly mix these chemicals into the filtered feed water. After dosing with the sodium bisulfate and antiscalant the filtered feed water may be considered a chemically pretreated feed water. The chemically treated feed water exits the first mobile container 100A. A pressure sensor S2 may be provided at the outlet of the first mobile container 100A that may provide feedback to the booster pump 120 to increase or decrease pumping pressure if the pressure of the chemically treated feed water is outside of a desired range.

The chemically treated feed water flows from the first mobile container 100A and into filter 170, for example, a screen filter with a particle retention size of about 5 μm in a second mobile container 100B. The flow rate and conductivity of the chemically treated feed water may be checked by a flow rate sensor S3 and a conductivity sensor S4 downstream of the filter 170. The chemically treated feed water is pressurized in another booster pump 180 and directed into a first RO unit 190. The RO-filtered water exiting the first RO unit 190 is checked for flow rate and conductivity by additional flow rate and conductivity sensors S3, S4 and is then directed into a membrane degasifier 200 which outputs the RO-filtered water as degassed RO-filtered water.

The degassed RO-filtered water is directed from the membrane degasifier 200 out of the second mobile container 100B and into a booster pump 210 in a third mobile container 100C. The degassed RO-filtered water is pressurized in the booster pump 210 and directed through a second RO unit 220. Retentate from the second RO unit 220 is recirculated back to the booster pump 180 and first RO unit 190 in the second mobile container 100B. The flow rate of the recirculated RO retentate may be monitored by another flow rate sensor S3. The two RO units 190, 220 and associated booster pumps thus form a dual pass RO filtration system. Permeate from the second RO unit, that may be considered dual-pass RO permeate is sent out of the third mobile container 100C to a downstream polishing sub-system. The flow rate and resistivity of the dual-pass RO permeate exiting the third mobile container 100C to the downstream polishing sub-system may be monitored by another flow rate sensor S3 and a resistivity sensor S4 which may be located within the third mobile container 100C.

The dual-pass RO permeate exiting the third mobile container 100C may exhibit a conductivity of less than 10 μS/cm and less than 50 ppb TOC.

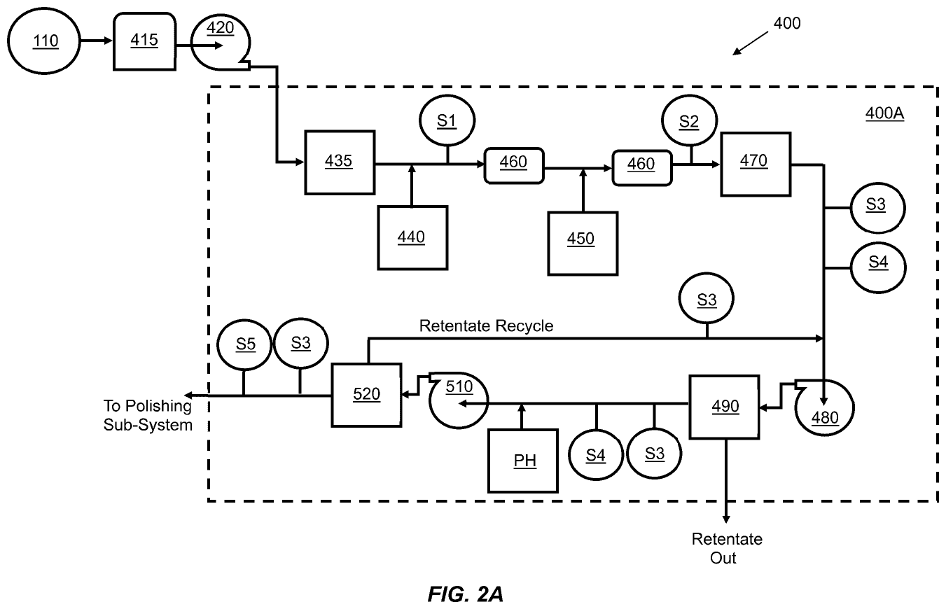

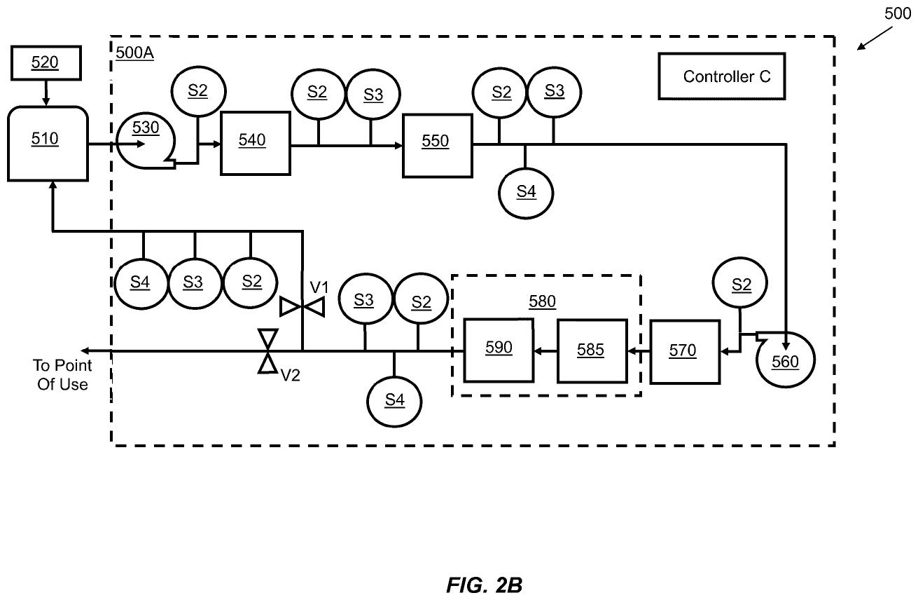

FIG. 1B illustrates a first embodiment of a polishing sub-system 300 for a mobile/temporary ultrapure water system as disclosed herein. The polishing sub-system 300 may be utilized, for example, for polishing pretreated water such as the dual-pass RO permeate produced in the makeup water sub-system of FIG. 1A or of that illustrated in FIG. 2A, described below. The polishing sub-system 300 includes a storage tank 310 with an inlet for receiving pretreated water from an upstream water pretreatment system, for example, a makeup water sub-system as illustrated in FIG. 1A or FIG. 2A. The storage tank 310 is insulated and may include an inert gas, for example, nitrogen blanketing system 320 to prevent pretreated water stored in the storage tank from absorbing undesired gasses, for example, carbon dioxide from the atmosphere. The storage tank 310 may be transported to a site for use in a mobile container, but is typically disposed outside of a mobile container during use, although in some embodiments, it may be included in a mobile container along with other system components.

Pretreated water is supplied from an outlet of the storage tank 310 to a booster pump 330 within a first mobile container 300A of the polishing sub-system 300. The pressure of the water exiting the booster pump 330 may be monitored with a pressure sensor S2. The booster pump 330 directs the pretreated water into an actinic radiation treatment apparatus 340 disposed on the mobile container 300A. The actinic radiation treatment apparatus 340 includes an inlet configured to receive the pretreated water from the outlet of the storage tank, and a source of actinic radiation configured to irradiate the pretreated water and destroy organic contaminants in the pretreated water to form a first partially treated water. The actinic radiation treatment apparatus 340 may be or may include an ultraviolet (UV) treatment unit which exposes the pretreated water to ultraviolet light to break down organic compounds within the pretreated water. The actinic radiation treatment apparatus 340 may utilize low pressure, 185 nm lamps for TOC destruction and may also provide 254 nm wavelength UV light for bacteria neutralization. Water exiting the actinic radiation treatment apparatus 340 (the first partially treated water) may exhibit less than 10 ppb TOC. The actinic radiation treatment apparatus 340 may be configured to perform an advanced oxidation process (AOP) on the pretreated water to break down the organic components in the pretreated water.

The first partially treated water is directed from an outlet of the actinic radiation treatment apparatus 340 to the inlet of an electrically driven water treatment apparatus 350 disposed on the mobile container 300A. The pressure and flow rate of the first partially treated water output from the actinic radiation treatment apparatus 340 may be monitored with pressure and flow rate sensors S2, S3. The electrically driven water treatment apparatus 350 has an inlet configured to receive the first partially treated water from the actinic radiation treatment apparatus 340 and is and configured to remove ionic contaminants from the first partially treated water to form a second partially treated water. In some embodiments, the electrically driven water treatment apparatus 350 may be or may include an electrodeionization or continuous electrodeionization apparatus (e.g., an IONPURE® VNX continuous electrodeionization (CEDI) module from Evoqua Water Technologies LLC). The second partially treated water exiting the electrically driven water treatment apparatus 350 may exhibit a resistivity of between 15 MΩ and 17 MΩ. Pressure, flow rate, and resistivity of the second partially treated water exiting the electrically driven water treatment apparatus 350 may be monitored with sensors S2, S3, S4 and the second partially treated water may be directed out of the first mobile container 300A. In some embodiments, readings from the pressure sensor S2 downstream of the electrically driven water treatment apparatus 350 may be used as feedback to control operation of the booster pump 330.

The second partially treated water exits the first mobile container 300A and is introduced into a booster pump 360 in a second mobile container 300B of the polishing sub-system 300. The booster pump 360 pressurizes the second partially treated water which is then directed into an ion exchange media apparatus 370 disposed in the second mobile container 300B. The pressure of the second partially treated water may be monitored with a pressure sensor S2 disposed between the booster pump 360 and ion exchange media apparatus 370. The ion exchange media apparatus 370 includes ion exchange media, and is configured to receive the second partially treated water from the electrically driven water treatment apparatus 350 via the booster pump 360 and remove one or more ionic species from the second partially treated water to form a third partially treated water. In some embodiments the ion exchange media apparatus 370 includes a vessel containing a mixed bed of anion and cation ion exchange media. The mixed bed of ion exchange media may perform a polishing operation to remove trace amounts of TDS to meet the final ultrapure water quality specifications for anions, metals, and silica. The third partially treated water exiting the ion exchange media apparatus 370 may exhibit a resistivity of about 18 MΩ.

The third partially treated water flows from an outlet of the ion exchange media apparatus 370 into a pressure driven filtration sub-system 380 disposed in the second mobile container 300B. The pressure driven filtration sub-system 380 is configured to filter particulate matter from the third partially treated water to form ultrapure water. The pressure driven filtration sub-system 380 is connectable or connected to a water distribution system that directs the ultrapure water to a point of use, for example to a semiconductor fabrication facility and for recirculation of a portion of the ultrapure water to the storage tank 310. The pressure driven filtration sub-system 380 may be or may include a membrane or cartridge filter with a particle retention size of from about 0.01 μm to about 0.1 μm, a nanofilter, or an ultrafilter. The relative amounts of ultrapure water directed to the point of use and recirculated back to the storage tank may be controlled by valves V1 and V2. Pressure, flow, and resistivity sensors S2, S3, and S4 may be provided on each of a conduit leading to the point of use and on a conduit for recirculating the ultrapure water back to the storage tank 310.

While a mobile, modular water treatment system for the production of ultrapure water including a makeup water sub-system 100 as shown in FIG. 1A and a polishing sub-system 300 as illustrated in FIG. 1B is provided in five (5) separate containers, it is to be understood that more or fewer containers may be used. Additionally and/or alternatively, the system could be housed in one or more towable trailers, thereby enabling the ultrapure water system to be easily deployed to (and removed from) a desired site.

FIG. 2A illustrates a second embodiment of a makeup water sub-system 400 for a mobile/temporary ultrapure water system as disclosed herein. As in the makeup water sub-system 100 the makeup water sub-system 400 receives feed water, which may meet standards for potable water from, for example, a municipal water source 410. The feed water is directed into a city water storage tank 420 which may be external to any mobile containers included in the system 400. A booster pump 420, which also may be provided external to any mobile containers included in the system 400, pumps feed water from the storage tank 420 to a multimedia filter 435 including, for example, anthracite, filter sand, 50 #garnet, flint sand, gravel, etc., disposed within a mobile container 400A of the system. In the makeup water sub-system 400 the multimedia filter 435 is utilized in place of the filter 130 of the makeup water sub-system 100 of FIG. 1A. Sodium bisulfate and antiscalant injection units 440 and 450 and associated static mixers 460 (corresponding to the sodium bisulfate and antiscalant injection units 140 and 150 and associated static mixers 160 of the makeup water sub-system 100 of FIG. 1A) are used to dose the filtered feed water downstream of the multimedia filter 435. The amount of sodium bisulfate dosed into the filtered feed water may be controlled based on oxygen-reduction potential (ORP) readings from an ORP sensor S1 disposed downstream of the injection point of the sodium bisulfate. After dosing with the sodium bisulfate and antiscalant the filtered feed water may be considered a chemically pretreated feed water. A pressure sensor S2 may be provided downstream of the sodium bisulfate and antiscalant injection points and associated static mixers 460 that may provide feedback to the booster pump 420 to increase or decrease pumping pressure if the pressure or flow rate of the chemically treated feed water is outside of a desired range.

The chemically treated feed water flows from the second static mixer 460 into filter 470, for example, a screen filter with a particle retention size of about 5 μm in the mobile container 400A. The flow rate and conductivity of the chemically treated feed water may be checked by a flow rate sensor S3 and a conductivity sensor S4 downstream of the filter 470. The chemically treated feed water is pressurized in another booster pump 480 within the mobile container 400A and is directed into a first RO unit 490 to produce RO-filtered water. The RO-filtered water exiting the first RO unit 490 is checked for flow rate and conductivity by additional flow rate and conductivity sensors S3, S4 and is then directed into another booster pump 510. Between the first RO unit and the booster pump 510, the RO-filtered water from the first RO unit 490 may be dosed with a pH adjustment agent, for example, sodium hydroxide from a source of pH adjustment agent PH. The sodium hydroxide converts CO₂ that nay be present in the RO-filtered water from the first RO unit 490 into its insoluble counterpart to facilitate rejection in a downstream RO unit. In the embodiment of FIG. 2A, the sodium hydroxide dosing is used instead of the membrane degasification that is used in the embodiment of FIG. 1A.

The pH adjusted RO-filtered water is directed from the booster pump 510 through a second RO unit 220 within the mobile container 400A. Retentate from the second RO unit 520 is recirculated back to the booster pump 480 and first RO unit 490. The flow rate of the recirculated RO retentate may be monitored by another flow rate sensor S3. The two RO units 490, 520 and associated booster pumps thus form a dual pass RO filtration system. Permeate from the second RO unit, that may be considered dual-pass RO permeate is sent out of the mobile container 400A to a downstream polishing sub-system. The flow rate and resistivity of the dual-pass RO permeate exiting the mobile container 400A to the downstream polishing sub-system may be monitored by another flow rate sensor S3 and a resistivity sensor S4 which may be located within the mobile container 400A.

The dual-pass RO permeate exiting the mobile container 400A may exhibit a conductivity of less than 10 μS/cm and less than 50 ppb TOC.

Unlike the makeup water sub-system 100 of FIG. 1A, all unit operations except for the city water storage tank 415 and initial booster pump 420 may be disposed within the same mobile container 400A in the makeup water sub-system 400.

FIG. 2B illustrates a second embodiment of a polishing sub-system 500 for a mobile/temporary ultrapure water system as disclosed herein. The polishing sub-system 500 may be utilized, for example, for polishing pretreated water such as the dual-pass RO permeate produced in the makeup water sub-system of FIG. 1A or FIG. 2A. The majority of the unit operations included in the polishing sub-system 500 are the same as those in the polishing sub-system 300 illustrated in FIG. 1B and unit operations in the polishing sub-system 500 that correspond to those in the polishing sub-system 300 are given reference numbers 5XX instead of 3XX as in the polishing sub-system 300.

One difference between the polishing sub-system 500 and the polishing sub-system 300 is that in the polishing sub-system 500 all unit operations except for the storage tank 510 and associated nitrogen blanketing system 520 may be disposed within the same mobile container 500A. Another difference between the polishing sub-system 500 and the polishing sub-system 300 is that in the polishing sub-system 500, the pressure driven filtration sub-system 580 includes not just a single filter as in the pressure driven filtration sub-system 380 of the polishing sub-system 300. Rather, the pressure driven filtration sub-system 580 of the polishing sub-system 500 includes a first filter 585, which may be a membrane or cartridge filter with a particle retention size of from about 0.01 μm to about 0.1 μm, followed by a membrane filtration apparatus, for example, an ultrafiltration unit 590.

A mobile, modular water treatment system for the production of ultrapure water including a makeup water sub-system 400 as shown in FIG. 2A and a polishing sub-system 500 as illustrated in FIG. 2B may include at least some of the various components housed in one or more mobile container(s) or trailer(s). For example, in an example including a makeup water sub-system 400 as shown in FIG. 2A and a polishing sub-system 500 as illustrated in FIG. 2B, two (2) separate mobile trailers may be utilized, with the multimedia filter, chemical pretreatment, and two RO devices housed in a first trailer (the makeup water sub-system mobile container 400A), while the TOC destruct, electrodeionization devices, ion exchange filtration device(s), cartridge filtration device(s), and ultrafiltration module(s) are housed in a second trailer (the polishing sub-system mobile container 500A). In some embodiments, a UPW storage tank may be located within the second trailer. However, in other embodiments, the storage tank may be located in a separate trailer or container. Additionally, in some embodiments, each trailer or container may include one or more booster pumps to move water through the system. Each trailer or container may be fluidly coupled to another adjacent trailer or container by way of appropriate piping. In this way, the ultrapure water system may be substantially modular and mobile, enabling the system to be easily deployed to, e.g., a microelectronics facility under construction so as to provide ultrapure rinse water prior to start-up of the facility.

While a mobile, modular water treatment system for the production of ultrapure water including a makeup water sub-system 400 as shown in FIG. 2A and a polishing sub-system 500 as illustrated in FIG. 2B includes the primary devices/module housed in only two trailers, it is to be understood that more or fewer trailers and/or containers may be utilized to house various components of the ultrapure water system in accordance with the present disclosure.

A mobile, modular water treatment system for the production of ultrapure water as disclosed herein may include the various types of sensors S1-S4 described above and a controller C to control operation of the different unit operations. The controller C is illustrated within a mobile container of the polishing sub-systems 300, 500, but may alternatively be located within a portion of a makeup water sub-system, may be located remote from the mobile, modular water treatment system or may include different control components located in a portion of the polishing sub-system and/or makeup water sub-system and/or remote from both. The controller C may be configured to control output of ultrapure water to a point of use such as a semiconductor fabrication facility based on measurements from water quality and flow sensors such as sensors S2, S3, and S4 disposed downstream of a pressure driven filtration sub-system 380, 580 of polishing sub-systems such as illustrated in FIGS. 1B and 2B.

The controller C may be implemented using one or more computer systems. The computer system may be, for example, a general-purpose computer such as those based on an Intel CORE®-type processor, an Intel XEON®-type processor, an Intel CELERON®-type processor, an AMD FX-type processor, an AMD RYZEN®-type processor, an AMD EPYC®-type processor, and AMD R-series or G-series processor, or any other type of processor or combinations thereof. Alternatively, the computer system may include programmable logic controllers (PLCs), specially programmed, special-purpose hardware, for example, an application-specific integrated circuit (ASIC) or controllers intended for analytical systems. In some embodiments, the controller C may be operably connected to or connectable to a user interface constructed and arranged to permit a user or operator to view relevant operational parameters of a system as disclosed herein, adjust said operational parameters, and/or stop operation of a system as needed. The user interface may include a graphical user interface (GUI) that includes a display configured to be interacted with by a user or service provider and output status information of the system.

The controller C can include one or more processors typically connected to one or more memory devices, which can comprise, for example, any one or more of a disk drive memory, a flash memory device, a RAM memory device, or other device for storing data. The one or more memory devices can be used for storing programs and data during operation of systems as disclosed herein. For example, the memory device may be used for storing historical data relating to measure flow or water quality parameters over a period.

Software, including programming code that implements embodiments as disclosed herein can be stored on a computer readable and/or writeable nonvolatile recording medium and then typically copied into the one or more memory devices wherein it can then be executed by the one or more processors. Such programming code may be written in any of a plurality of programming languages, for example, ladder logic, Python, Java, Swift, Rust, C, C#, or C++, G, Eiffel, VBA, or any of a variety of combinations thereof.

In some embodiments system components as disclosed herein may be utilized in a method of facilitating temporary production of ultrapure water for use in a pre-commissioned semiconductor fabrication facility as primary level water for rinse or makeup water. The method may include providing a storage tank configured to connect to and receive pretreated water from an upstream water pretreatment system and delivering a mobile platform to the pre-commissioned semiconductor fabrication facility. As discussed above with respect to the disclosed polishing sub-systems, the mobile platform may include an actinic radiation treatment apparatus having an inlet configured to connect to and receive the pretreated water from the storage tank, and a source of actinic radiation configured to irradiate the pretreated water to destroy organic contaminants in the pretreated water and form a first partially treated water. The mobile platform may include an electrically driven water treatment apparatus having an inlet configured to connect to and receive the first partially treated water from the actinic radiation treatment apparatus and to remove ionic contaminants from the first partially treated water and form a second partially treated water. The mobile platform my further include an ion exchange media apparatus including ion exchange media, the ion exchange media apparatus configured to connect to and receive the second partially treated water from the electrically driven water treatment apparatus and remove one or more ionic species from the second partially treated water and form a third partially treated wastewater and a pressure driven filtration sub-system configured to connect to and receive the third partially treated water from the ion exchange media apparatus and remove particulate matter from the third partially treated water to form the ultrapure water. The pressure driven filtration sub-system may include an outlet connectable to a water distribution system for the pre-commissioned semiconductor fabrication facility and for recirculation of a portion of the ultrapure water to the storage tank.

Providing the storage tank may include providing a nitrogen blanket production sub-system configured to maintain a blanket of nitrogen gas over the pretreated water in the storage tank.

The method may include configuring the actinic radiation treatment apparatus to perform an advanced oxidation process on the pretreated water.

The method may include configuring the electrically driven water treatment apparatus to subject the first partially treated water to a continuous electrodeionization process and/or configuring the ion exchange media apparatus to pass the second partially treated water through a mixed bed of ion exchange media and/or configuring the pressure driven filtration sub-system to include an upstream particle filter configured to remove particulate matter with a size of about 0.1 μm or greater from the third partially treated water, and an ultrafiltration apparatus downstream of the upstream particle filter.

The method may further include providing water quality and flow sensors to be disposed downstream of the pressure driven filtration sub-system and a controller configured to control output of the ultrapure water to the semiconductor fabrication facility based on measurements from the water quality and flow sensors.

The method may further include providing instructions to mix recirculated ultrapure water from the pressure driven filtration sub-system with the pretreated water in the storage tank.

The method may further include providing a second mobile platform including the upstream water pretreatment system.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A mobile, modular water treatment system for the production of ultrapure water for use as primary level water for rinse or makeup water in a semiconductor fabrication facility, the system comprising:
a storage tank having an inlet configured to receive pretreated water from an upstream water pretreatment system, and an outlet;
a mobile platform;
an actinic radiation treatment apparatus disposed on the mobile platform, the actinic radiation treatment apparatus having an inlet configured to receive the pretreated water from the outlet of the storage tank, and a source of actinic radiation configured to irradiate the pretreated water and destroy organic contaminants in the pretreated water to form a first partially treated water;
an electrically driven water treatment apparatus disposed on the mobile platform, the electrically driven water treatment apparatus having an inlet configured to receive the first partially treated water from the actinic radiation treatment apparatus and configured to remove ionic contaminants from the first partially treated water to form a second partially treated water;
an ion exchange media apparatus disposed on the mobile platform and including ion exchange media, the ion exchange media apparatus configured to receive the second partially treated water from the electrically driven water treatment apparatus and remove one or more ionic species from the second partially treated water to form a third partially treated water; and
a pressure driven filtration sub-system disposed on the mobile platform and configured to filter particulate matter from the third partially treated water to form the ultrapure water, the pressure driven filtration sub-system being connectable to a water distribution system for the semiconductor fabrication facility and for recirculation of a portion of the ultrapure water to the storage tank.

2. The system of claim 1, wherein the storage tank is insulated and includes a nitrogen blanket system configured to cover the pretreated water in the storage tank with nitrogen gas.

3. The system of claim 1, wherein the actinic radiation treatment apparatus is configured to perform an advanced oxidation process on the pretreated water.

4. The system of claim 1, wherein the electrically driven water treatment apparatus includes a continuous electrodeionization apparatus.

5. The system of claim 1, wherein the ion exchange media apparatus includes a mixed bed of ion exchange media.

6. The system of claim 1, wherein the pressure driven filtration sub-system includes a first particle filter having a particle retention size of about 0.1 μm or greater.

7. The system of claim 6, wherein the pressure driven filtration sub-system further includes a membrane filtration apparatus.

8. The system of claim 7, wherein the membrane filtration apparatus includes an ultrafilter.

9. The system of claim 1, configured produce the ultrapure water with an electrical resistivity of greater than or equal to 18 MΩ, a total organic contaminant level of less than 10 ppb, and 1000 particles per liter or fewer having a size of from 0.1-0.2 microns from the pretreated water having an electrical resistivity of 0.1 MΩ or less, and a total organic contaminant level of 50 ppb or less.

10. The system of claim 1, wherein the mobile platform includes at least two mobile containers.

11. The system of claim 1, wherein the storage tank includes a second inlet configured to receive ultrapure water.

12. The system of claim 1, further comprising water quality and flow sensors disposed downstream of the pressure driven filtration sub-system, and a controller configured to control output of the ultrapure water to the semiconductor fabrication facility based on measurements from the water quality and flow sensors.

13. The system of claim 1, further comprising a second mobile platform configured to produce the pretreated water from city water and deliver the pretreated water to the storage tank.

14. A method of facilitating temporary production of ultrapure water for use in a pre-commissioned semiconductor fabrication facility as primary level water for rinse or makeup water, the method comprising:
providing a storage tank configured to connect to and receive pretreated water from an upstream water pretreatment system;
delivering a mobile platform to the pre-commissioned semiconductor fabrication facility, the mobile platform including:
an actinic radiation treatment apparatus having an inlet configured to connect to and receive the pretreated water from the storage tank, and a source of actinic radiation configured to irradiate the pretreated water to destroy organic contaminants in the pretreated water and form a first partially treated water;
an electrically driven water treatment apparatus having an inlet configured to connect to and receive the first partially treated water from the actinic radiation treatment apparatus and to remove ionic contaminants from the first partially treated water and form a second partially treated water;
an ion exchange media apparatus including ion exchange media, the ion exchange media apparatus configured to connect to and receive the second partially treated water from the electrically driven water treatment apparatus and remove one or more ionic species from the second partially treated water and form a third partially treated wastewater; and
a pressure driven filtration sub-system configured to connect to and receive the third partially treated water from the ion exchange media apparatus and remove particulate matter from the third partially treated water to form the ultrapure water, the pressure driven filtration sub-system including an outlet connectable to a water distribution system for the pre-commissioned semiconductor fabrication facility and for recirculation of a portion of the ultrapure water to the storage tank.

14. The method of claim 13, wherein providing the storage tank includes providing a nitrogen blanket production sub-system configured to maintain a blanket of nitrogen gas over the pretreated water in the storage tank.

15. The method of claim 13, further comprising configuring the actinic radiation treatment apparatus to perform an advanced oxidation process on the pretreated water.

16. The method of claim 13, further comprising configuring the electrically driven water treatment apparatus to subject the first partially treated water to a continuous electrodeionization process.

17. The method of claim 13, further comprising configuring the ion exchange media apparatus to pass the second partially treated water through a mixed bed of ion exchange media.

18. The method of claim 13, further comprising configuring the pressure driven filtration sub-system to include an upstream particle filter configured to remove particulate matter with a size of about 0.1 μm or greater from the third partially treated water, and an ultrafiltration apparatus downstream of the upstream particle filter.

19. The method of claim 13, further comprising providing water quality and flow sensors to be disposed downstream of the pressure driven filtration sub-system and a controller configured to control output of the ultrapure water to the semiconductor fabrication facility based on measurements from the water quality and flow sensors.

20. The method of claim 13, further comprising providing instructions to mix recirculated ultrapure water from the pressure driven filtration sub-system with the pretreated water in the storage tank.

21. The method of claim 13, further comprising providing a second mobile platform including the upstream water pretreatment system.
